(19) United States
(12) Patent Application Publication
(10) Pub. No.: US 2024/0340780 A1
(43) Pub. Date: Oct. 10, 2024

(54) COMMUNICATION METHOD AND APPARATUS

(71) Applicant: GUANGDONG OPPO MOBILE TELECOMMUNICATIONS CORP., LTD., Dongguan (CN)

(72) Inventor: Xinlei YU, Dongguan (CN)

(21) Appl. No.: 18/750,334

(22) Filed: Jun. 21, 2024

Related U.S. Application Data
(63) Continuation of application No. PCT/CN2021/140195, filed on Dec. 21, 2021.

(51) Int. Cl. H04W 48/16; H04L 5/00

(52) U.S. Cl. CPC H04W 48/16; H04L 5/0005; H04L 5/0048

(57) ABSTRACT

This application provides a communication method and apparatus. The method includes: A target terminal sends a sensing request to at least one auxiliary terminal. The sensing request includes configuration information of a sensing signal. In this manner, the target terminal sends the configuration information of the sensing signal to the auxiliary terminal. Sending and receiving of the sensing signal are coordinated between the target terminal and the auxiliary terminal.

### CROSS-REFERENCE TO RELATED APPLICATIONS

This application is a continuation of International Application No. PCT/CN2021/140195, filed on Dec. 21, 2021, the disclosure of which is hereby incorporated by reference in its entirety.

### TECHNICAL FIELD

This application relates to the field of communications technologies, and in particular, to a communication method and apparatus.

### BACKGROUND

A wireless electromagnetic wave signal used in a cellular network (including a 5G network) can not only be used for wireless data transmission and communication, but also have an environment sensing capability, for example, motion or gesture recognition of a user, respiration monitoring, measurement of a moving speed of a terminal, environment imaging, and weather monitoring. Therefore, a cellular network in the future may be further used to obtain sensing information.

In related technologies, a sensing capability is supported in a B5G network. A sensing function may be implemented in a 3rd generation partnership project (3GPP) network by adding a sensing control network element (Sensing Function, SF). When an application sends a sensing request for a target terminal to a core network device of the 3GPP network, the core network device selects a correct access network device by using an SF or an access and mobility management function (AMF), or an auxiliary terminal device performs a sensing-related operation and configures a time-frequency position of a sensing reference signal.

However, because the SF or the AMF does not master information about an air interface resource, when a time-frequency position of a sensing signal is configured, an access network device or a terminal device needs to report auxiliary information related to the time-frequency position of the sensing signal to the AMF or the SF. This increases signaling overheads and a delay.

### SUMMARY

Embodiments of this application provide a communication method and apparatus, to resolve a technical problem of relatively large signaling overheads and a relatively large delay of sensing in the conventional technologies.

A first aspect of this application provides a communication method. The method includes:
sending, by a target terminal, a sensing request to at least one auxiliary terminal, where the sensing request includes configuration information of a sensing signal.

In an optional implementation, before the target terminal sends the sensing request to the at least one auxiliary terminal, the method further includes:
receiving, by the target terminal, a sensing instruction sent by a network device, where the sensing instruction includes a type of sensing to be executed.

That the target terminal sends the sensing request to the at least one auxiliary terminal includes that
if the type of sensing to be executed is bistatic sensing between devices, the target terminal sends the sensing request to the at least one auxiliary terminal.

In an optional implementation, the type of sensing includes: bistatic sensing between terminal devices, downlink bistatic sensing between a terminal device and an access network device, uplink bistatic sensing between a terminal device and an access network device, and monostatic sensing of a terminal device.

In an optional implementation, the configuration information of the sensing signal includes at least one of the following: a type of the sensing signal, start and end times of the sensing signal, and a frequency domain resource position of the sensing signal.

In an optional implementation, after the target terminal sends the sensing request to the at least one auxiliary terminal, the method further includes:
receiving, by the target terminal, a sensing request response separately sent by the at least one auxiliary terminal, where the sensing request response is used to feed back whether the at least one auxiliary terminal supports sensing to be executed.

In an optional implementation, the sensing request response includes configuration information of a sensing signal correspondingly supported by the at least one auxiliary terminal.

In an optional implementation, after the target terminal receives the sensing request response sent by the at least one auxiliary terminal, the method further includes:
sending, by the target terminal, the sensing signal on a time-frequency resource indicated by the sensing request response.

In an optional implementation, after the target terminal sends the sensing signal on the time-frequency resource indicated by the sensing request response, the method further includes:
receiving, by the target terminal, sensing data sent by the at least one auxiliary terminal.

The target terminal sends the sensing data to the network device.

In an optional implementation, after the target terminal receives the sensing request response sent by the auxiliary terminal, the method further includes:
receiving, by the target terminal, the sensing signal on a time-frequency resource indicated by the sensing request response.

The target terminal measures the sensing signal to generate sensing data.

The target terminal sends the sensing data to the network device.

In an optional implementation, the sensing request is carried in a sidelink discovery message.

In an optional implementation, a transmission manner of the sensing request includes broadcast.

In an optional implementation, the sensing request response is carried in a sidelink discovery message.

In an optional implementation, a transmission manner of the sensing request response includes unicast.

In an optional implementation, the network device includes an access and mobility management function network element and/or a sensing control network element.

In an optional implementation, the sensing signal includes a sidelink sensing signal.

A second aspect of this application provides a communication method. The method includes:

An auxiliary terminal receives a sensing request sent by a target terminal. The sensing request includes configuration information of a sensing signal.

In an optional implementation, the configuration information of the sensing signal includes at least one of the following: a type of the sensing signal, start and end times of the sensing signal, and a frequency domain resource position of the sensing signal.

In an optional implementation, after the auxiliary terminal receives the sensing request sent by the target terminal, the method further includes:
sending, by the auxiliary terminal, a sensing request response to the target terminal, where the sensing request response is used to feed back whether the auxiliary terminal supports sensing to be executed.

In an optional implementation, the sensing request response includes configuration information of a sensing signal supported by the auxiliary terminal.

In an optional implementation, after the auxiliary terminal sends the sensing request response to the target terminal, the method further includes:
sending, by the auxiliary terminal, the sensing signal on a time-frequency resource indicated by the sensing request response.

In an optional implementation, after the auxiliary terminal sends the sensing request response to the target terminal, the method further includes:
receiving, by the auxiliary terminal, the sensing signal on a time-frequency resource indicated by the sensing request response.

The auxiliary terminal measures the sensing signal to generate sensing data.

The auxiliary terminal sends the sensing data to the target terminal.

In an optional implementation, the sensing request is carried in a sidelink discovery message.

In an optional implementation, a transmission manner of the sensing request includes broadcast.

In an optional implementation, the sensing request response is carried in a sidelink discovery message.

In an optional implementation, a transmission manner of the sensing request response includes unicast.

In an optional implementation, the sensing signal includes a sidelink sensing signal.

A third aspect of this application provides a communications apparatus. The apparatus includes:
a sending module, configured to send a sensing request to at least one auxiliary terminal, where the sensing request includes configuration information of a sensing signal.

In an optional implementation, the apparatus further includes: a receiving module, configured to receive a sensing instruction sent by a network device. The sensing instruction includes a type of sensing to be executed.

The sending module is specifically configured to: if the type of sensing to be executed is bistatic sensing between devices, send the sensing request to the at least one auxiliary terminal.

In an optional implementation, the type of sensing includes: bistatic sensing between terminal devices, downlink bistatic sensing between a terminal device and an access network device, uplink bistatic sensing between a terminal device and an access network device, and monostatic sensing of a terminal device.

In an optional implementation, the configuration information of the sensing signal includes at least one of the following: a type of the sensing signal, start and end times of the sensing signal, and a frequency domain resource position of the sensing signal.

In an optional implementation, the receiving module is further configured to receive a sensing request response separately sent by the at least one auxiliary terminal. The sensing request response is used to feed back whether the at least one auxiliary terminal supports sensing to be executed.

In an optional implementation, the sensing request response includes configuration information of a sensing signal correspondingly supported by the at least one auxiliary terminal.

In an optional implementation, the sending module is further configured to send the sensing signal on a time-frequency resource indicated by the sensing request response.

In an optional implementation, the receiving module is further configured to receive sensing data sent by the at least one auxiliary terminal.

The sending module is further configured to send the sensing data to the network device.

In an optional implementation, the receiving module is further configured to receive the sensing signal on a time-frequency resource indicated by the sensing request response.

The apparatus further includes: a processing module, configured to measure the sensing signal to generate sensing data.

The sending module is further configured to send the sensing data to the network device.

In an optional implementation, the sensing request is carried in a sidelink discovery message.

In an optional implementation, a transmission manner of the sensing request includes broadcast.

In an optional implementation, the sensing request response is carried in a sidelink discovery message.

In an optional implementation, a transmission manner of the sensing request response includes unicast.

In an optional implementation, the network device includes an access and mobility management function network element and/or a sensing control network element.

In an optional implementation, the sensing signal includes a sidelink sensing signal.

A fourth aspect of this application provides a communications apparatus. The apparatus includes:

A receiving module is configured to receive a sensing request sent by a target terminal. The sensing request includes configuration information of a sensing signal.

In an optional implementation, the configuration information of the sensing signal includes at least one of the following: a type of the sensing signal, start and end times of the sensing signal, and a frequency domain resource position of the sensing signal.

In an optional implementation, the apparatus further includes:
a sending module, configured to send a sensing request response to the target terminal, where the sensing request response is used to feed back whether the communications apparatus supports sensing to be executed.

In an optional implementation, the sensing request response includes configuration information of a sensing signal supported by the communications apparatus.

In an optional implementation, the sending module is specifically configured to send the sensing signal on a time-frequency resource indicated by the sensing request response.

In an optional implementation, the receiving module is further configured to receive the sensing signal on a time-frequency resource indicated by the sensing request response.

The apparatus further includes: a processing module, configured to measure the sensing signal to generate sensing data.

The sending module is further configured to send the sensing data to the target terminal.

In an optional implementation, the sensing request is carried in a sidelink discovery message.

In an optional implementation, a transmission manner of the sensing request includes broadcast.

In an optional implementation, the sensing request response is carried in a sidelink discovery message.

In an optional implementation, a transmission manner of the sensing request response includes unicast.

In an optional implementation, the sensing signal includes a sidelink sensing signal.

A fifth aspect of this application provides a terminal device, including:
a processor, a memory, a transmitter, and an interface for communicating with a terminal device.

The memory stores computer execution instructions.

The processor executes the computer execution instructions stored in the memory, so that the processor is enabled to perform the communication method according to the first aspect.

A sixth aspect of this application provides a terminal device, including:
a processor, a memory, a transmitter, and an interface for communicating with a terminal device.

The memory stores computer execution instructions.

The processor executes the computer execution instructions stored in the memory, so that the processor is enabled to perform the communication method according to the second aspect.

A seventh aspect of this application provides a chip, including a processor configured to invoke a computer program from the memory and run the computer program, to enable a device installed with the chip to perform the method according to the first aspect.

An eighth aspect of this application provides a chip, including a processor configured to invoke a computer program from the memory and run the computer program, to enable a device installed with the chip to perform the method according to the second aspect.

A ninth aspect of this application provides a computer-readable storage medium configured to store a computer program. A computer is enabled by using the computer program to perform the method according to the first aspect.

A tenth aspect of this application provides a computer-readable storage medium configured to store a computer program. A computer is enabled by using the computer program to perform the method according to the second aspect.

An eleventh aspect of this application provides a computer program product, including computer instructions. The computer instructions are executed by a processor to implement the method according to the first aspect.

A twelfth aspect of this application provides a computer program product, including computer instructions. The computer instructions are executed by a processor to implement the method according to the second aspect.

A thirteenth aspect of this application provides a computer program. A computer is enabled by using the computer program to perform the method according to the first aspect.

A fourteenth aspect of this application provides a computer program. A computer is enabled by using the computer program to perform the method according to the second aspect.

A fifteenth aspect of this application provides an apparatus. The apparatus may include at least one processor and an interface circuit. Related program instructions are executed in the at least one processor, to enable the apparatus to implement the method according to the first aspect.

A sixteenth aspect of this application provides an apparatus. The apparatus may include at least one processor and an interface circuit. Related program instructions are executed in the at least one processor, to enable the communications apparatus to implement the method according to the second aspect.

A seventeenth aspect of this application provides a communications apparatus. The apparatus is configured to perform the method according to the first aspect.

An eighteenth aspect of this application provides a communications apparatus. The apparatus is configured to perform the method according to the second aspect.

According to the communication method and apparatus provided in embodiments of this application, the target terminal sends the sensing request to the at least one auxiliary terminal. The sensing request includes the configuration information of the sensing signal. In this manner, the target terminal sends the configuration information of the sensing signal to the auxiliary terminal. Sending and receiving of the sensing signal are coordinated between the target terminal and the auxiliary terminal. The configuration information of the sensing signal does not need to be reported to the network device, thereby reducing signaling overheads and a delay.

### BRIEF DESCRIPTION OF DRAWINGS

To describe the technical solutions in the present application or a conventional technology more clearly, the following briefly describes the accompanying drawings required for describing embodiments or the conventional technology. Apparently, the accompanying drawings in the following description show some embodiments of the present application, and persons of ordinary skill in the art may still derive other drawings from these accompanying drawings without creative efforts.

FIG. 1 is a schematic diagram of a mode A in sidelink transmission according to an embodiment of this application.

FIG. 2 is a schematic diagram of a mode B in sidelink transmission according to an embodiment of this application.

FIG. 3 is a schematic diagram of a scenario of a communication method according to an embodiment of this application.

FIG. 4 is a signaling interaction diagram of a communication method according to an embodiment of this application.

FIG. 5 is a signaling interaction diagram of another communication method according to an embodiment of this application.

FIG. 6 is a signaling interaction diagram of still another communication method according to an embodiment of this application.

FIG. 7 is a schematic diagram of a structure of a communications apparatus according to an embodiment of this application.

FIG. 8 is a schematic diagram of a structure of another communications apparatus according to an embodiment of this application.

FIG. 9 is a schematic diagram of a structure of a communications device according to an embodiment of this application.

### DESCRIPTION OF EMBODIMENTS

To make the objectives, technical solutions, and advantages of the present application clearer, the following clearly describes the technical solutions in embodiments of the present application with reference to the accompanying drawings in embodiments of the present application. Apparently, the described embodiments are some rather than all of embodiments of the present application. All other embodiments obtained by persons of ordinary skill in the art based on embodiments of the present application without creative efforts fall within the protection scope of the present application.

In the specification, claims, and accompanying drawings of embodiments of this application, the terms “first”, “second”, and the like are intended to distinguish between similar objects but do not necessarily indicate a specific order or sequence. It should be understood that the data used in this way may be interchangeable under appropriate circumstances such that embodiments in this application described herein are, for example, capable of being implemented in an order different from that illustrated or described herein. In addition, the terms “include” and “have” and any other variants thereof are intended to cover the non-exclusive inclusion. For example, a process, method, system, product, or device that includes a series of steps or units is not necessarily limited to those expressly listed steps or units, but may include other steps or units not expressly listed or inherent to such process, method, product, or device.

It should be understood that the terms “system” and “network” in this specification may often be used interchangeably in this specification. In this specification, the term “and/or” is merely an association relationship that describes associated objects, and represents that there may be three relationships. For example, A and/or B may represent three cases: only A exists, both A and B exist, and only B exists. In addition, the character “/” in this specification generally indicates an “or” relationship between the associated objects.

The following describes the technical solutions in embodiments of this application with reference to the accompanying drawings in embodiments of this application. Apparently, the described embodiments are some rather than all of embodiments of this application. All other embodiments obtained by persons of ordinary skill in the art based on embodiments of this application without creative efforts fall within the protection scope of this application.

The following describes a sidelink (SL).

Device-to-device (D2D) communication is a sidelink transmission technology. Different from a conventional cellular system in which communication data is received or transmitted via a network device, a vehicle-to-everything system uses terminal device-to-terminal device direct communication, which therefore has higher spectral efficiency and lower transmission latency. In the 3rd generation partnership project (3GPP), two transmission modes are defined: a mode A and a mode B respectively.

FIG. 1 is a schematic diagram of a mode A in sidelink transmission according to an embodiment of this application. As shown in FIG. 1, in the mode A, a transmission resource of a terminal device is allocated by a network device. The terminal device sends data on a sidelink based on the resource allocated by the network device. The network device may allocate, to the terminal device, a resource for single transmission; or may allocate, to the terminal device, a resource for semi-static transmission.

FIG. 2 is a schematic diagram of a mode B in sidelink transmission according to an embodiment of this application. As shown in FIG. 2, in the mode B, a vehicle-mounted terminal selects a resource from a resource pool to perform data transmission.

It should be understood that D2D is divided into different stages for research in 3GPP.

A proximity-based service (ProSe) is mainly for a service of a public safety type.

Vehicle-to-everything (V2X) communication is mainly for a vehicle-to-vehicle communication service in a scenario of a relatively high moving speed and a vehicle-to-pedestrian communication service.

A wearable device (FeD2D) is mainly for a scenario of a low moving speed and low power access.

Based on long term evolution (LTE) V2X, new radio (NR) is not limited to a broadcast scenario, and is further extended to a unicast scenario and a multicast scenario.

Two resource authorization modes: mode-1 and mode-2 are defined in NR V2X. This is similar to LTE V2X. Further, a user may be in a mixed mode. To be specific, the user may use mode-1 to obtain a resource, and may also use mode-2 to obtain a resource. Resource obtaining is indicated in a sidelink grant manner. To be specific, a sidelink grant indicates time-frequency positions of corresponding physical sidelink control channel (PSCCH) and physical sidelink shared channel (PSSCH) resources.

In addition, different from LTE V2X, in addition to a hybrid automatic repeat request (HARQ) independently initiated by a terminal device without feedback, feedback-based HARQ retransmission is introduced into NR V2X, which is not limited to unicast communication and also includes multicast communication.

The following describes broadcast of a Uu system message.

A master information block (MIB) is broadcast by using a broadcast control channel (BCCH) mapped to a broadcast channel (BCH). A system information block (SIB) 1 and OSI are broadcast by using a BCCH mapped to a downlink shared channel (DL-SCH), and are transparent to Layer 2 protocols on a user plane that include a packet data convergence protocol (PDCP), a radio link control protocol (RLC), and a medium access control (MAC) layer. In other words, abstract syntax notation one (ASN.1) encoding is performed at a radio resource control (RRC) layer, and then an encoding result is directly sent to a physical layer for processing.

The following describes a discovery process.

A model A discovery (“I am here”) model defines an announcing terminal and a monitoring terminal for a terminal device participating in Discovery.

The announcing terminal announces some information. The announced information may be used by a neighboring terminal device with discovery permission. The monitoring terminal is a terminal that monitors some information in which the terminal interests near the announcing terminal.

In the model A discovery model, the announcing terminal broadcasts a discovery message at a predefined discovery interval, and the monitoring terminal interested in the message reads and processes the discovery message. This model is equivalent to “I am here”, because the announcing terminal broadcasts information about itself.

A model B discovery (“Who is there?”/“Are you there?”) model defines a discovering terminal and a discovered terminal for UE participating in Discovery.

The discovering terminal sends a request. The request includes some information about what the discovering terminal is interested to discover. After receiving a request message, the discovered terminal may respond to some information related to the request of the discoverer.

The model B discovery model is equivalent to “Who is there?/Are you there?”, because the discovering terminal sends information about another terminal, for example, a terminal that expects to receive a response. The information may be a ProSe application identifier corresponding to a group. A member of the group may respond.

The following describes a system architecture of a 5G network.

In a system architecture of a 5G network, user equipment (UE) implements an access stratum connection, exchanges access stratum messages, and performs wireless data transmission with an access network (AN) by using a Uu interface, and the UE implements a non-access stratum (NAS) connection and exchanges NAS messages with an AMF by using an N1 interface. The AMF is used for a mobility management function in a core network, and a session management network element (SMF) is used for a session management function in the core network. In addition to performing mobility management on the UE, the AMF is also responsible for forwarding messages related to session management between the UE and the SMF. A policy control network element (PCF) is used for a policy management function in the core network, and is responsible for formulating policies related to mobility management, session management, charging, and the like for the UE. A user plane function network element (UPF) is used for user plane functions in the core network, to perform data transmission with an external data network by using an N6 interface and perform data transmission with an AN by using an N3 interface.

The following describes a sensing signal.

A wireless electromagnetic wave signal used in a cellular network (including a 5G network) can not only be used for wireless data transmission and communication, but also have an environment sensing capability, for example, motion or gesture recognition of a user, respiration monitoring, measurement of a moving speed of a terminal, environment imaging, and weather monitoring. Therefore, a cellular network in the future may be further used to obtain sensing information.

In a related technology, a sensing capability is supported in a B5G network. A sensing function is supported in a 3GPP network by adding a sensing control network element (Sensing Function) and a corresponding procedure. When an application sends a sensing request for a target terminal to a core network of a 3GPP network, the core network selects a correct access network device or auxiliary UE by using the sensing control network element or the AMF, triggers a capability of performing sensing-related wireless measurement, starts measurement of sensing information, and generates a sensing result.

Main wireless sensing scenarios of integrated sensing and communication are as follows:
(1) A link for base station monostatic sensing: A base station sends a sensing signal and receives an echo signal.
(2) A link for base station to base station bistatic sensing: A base station B receives a sensing signal sent by a base station A.
(3) An uplink for bistatic sensing: A base station receives a sensing signal sent by a terminal.
(4) A downlink for bistatic sensing: A terminal receives a sensing signal sent by a base station.
(5) A link for terminal monostatic sensing: A terminal sends a sensing signal and receives an echo signal.
(6) A link for terminal device to terminal device bistatic sensing: A terminal B receives a sensing signal sent by a terminal A.

It should be noted that, in an initial stage of integrated sensing and communication in B5G, it is considered to perform a sensing action by reusing existing reference signals such as a sounding reference signal (SRS), a demodulation reference signal (DMRS), a channel state information reference signal (CSI-RS), a phase tracking reference signal (PTRS), and a network positioning reference signal (PRS), as much as possible, without introducing excessive air interface enhancement.

However, for sensing of a target terminal or a target area, the SF or the AMF is responsible for selecting an appropriate access network device or auxiliary terminal to perform a sensing-related operation, and configuring a time-frequency position of a sensing reference signal. Because the SF or the AMF does not master information about an air interface resource, when a time-frequency position of a sensing signal is configured, an access network device or a terminal device needs to report auxiliary information related to the time-frequency position of the sensing signal to the AMF or the SF. This increases signaling overheads and a delay.

To resolve the foregoing technical problem, embodiments of this application provide a communication method and apparatus. A target terminal sends configuration information of a sensing signal to an auxiliary terminal. Sending and receiving of the sensing signal are coordinated between the target terminal and the auxiliary terminal. The configuration information of the sensing signal does not need to be reported to a network device, thereby reducing signaling overheads and a delay.

The following uses an example to describe an application scenario of this application.

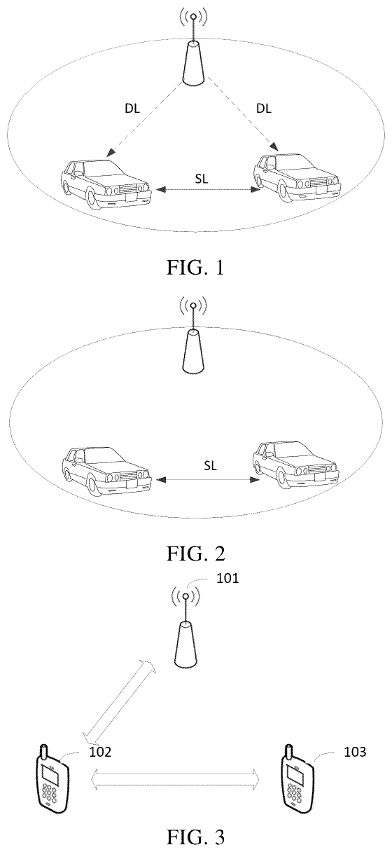

FIG. 3 is a schematic diagram of a scenario of a communication method according to an embodiment of this application. As shown in FIG. 3, a network device 101 may send a sensing instruction to a target terminal 102 to instruct the target terminal 102 to perform sidelink sensing. If a type of the sidelink sensing is bistatic sensing between devices, the target terminal 102 may send a sensing request to at least one auxiliary terminal 103 to transmit configuration information of the sensing signal. Then, the auxiliary terminal 103 sends a sensing request response to the target terminal 102 to feed back whether the auxiliary terminal 103 supports the sidelink sensing to be executed. Then, sidelink sensing is performed between the target terminal 102 and the auxiliary terminal 103 to obtain sensing data. The sensing data is sent to the network device 101.

The target terminal 102 and the auxiliary terminal 103 each include but are not limited to a satellite or cellular phone, a personal communications system (PCS) terminal that may combine a cellular wireless phone with data processing, a fax, and a data communication capability; a PDA that may include a wireless phone, a pager, Internet/Intranet access, a web browser, a notebook, a calendar, and/or a global positioning system (GPS) receiver; and a conventional laptop and/or palmtop receiver or another electronic apparatus including a wireless telephone transceiver. The terminal device may be an access terminal, user equipment (UE), a subscriber unit, a subscriber station, a mobile site, a mobile station, a remote station, a remote terminal, a mobile device, a user terminal, a terminal, a wireless communications device, a user agent, or a user apparatus. The access terminal may be a cellular phone, a cordless phone, a session initiation protocol (SIP) phone, a wireless local loop (WLL) station, a personal digital assistant (PDA), a handheld device having a wireless communication function, a computing device or another processing device connected to a wireless modem, a vehicle-mounted device, a wearable device, a terminal device in a 5G network, a terminal device in a future evolved PLMN, or the like.

The network device 101 may provide communication coverage for a specific geographic area, and may communicate with a terminal device within the coverage area. Optionally, the network device 101 may be a base transceiver station (BTS) in a GSM system or a CDMA system, may be a NodeB (NB) in a WCDMA system, or may be an evolved NodeB (eNB or eNodeB) in an LTE system, or a radio controller in a cloud radio access network (CRAN). Alternatively, the network device may be a mobile switching center, a relay station, an access point, a vehicle-mounted device, a wearable device, a concentrator, a switch, a bridge, a router, a network device in a 5G network, a network device in a future evolved public land mobile network (PLMN), or the like.

The following uses communications devices such as a target terminal, an auxiliary terminal, and a network device as an example to describe the technical solutions in embodiments of this application in detail by using specific embodiments. The following specific embodiments may be combined with each other. For a same or similar concept or process, details may not be described in some embodiments.

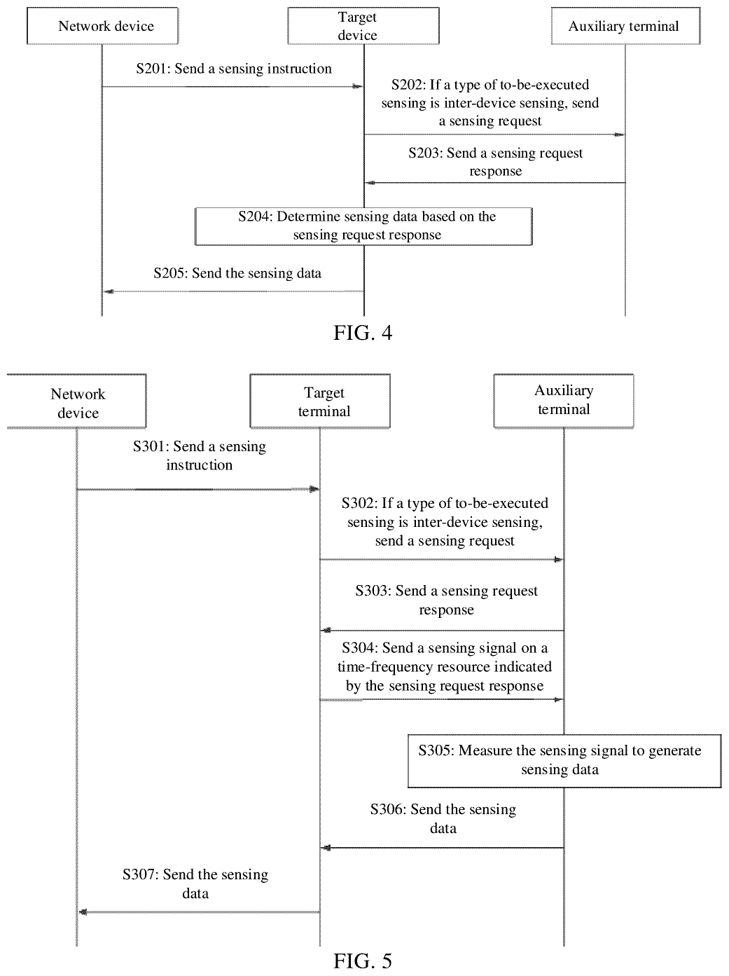

FIG. 4 is a diagram of signaling interaction of a communication method according to an embodiment of this application. This embodiment of this application relates to a process of performing sidelink sensing. As shown in FIG. 4, the method includes the following steps:

S201: A network device sends a sensing instruction to a target terminal. The sensing instruction includes a type of sensing to be executed.

In this application, when sensing needs to be performed, the network device may send the sensing instruction to the target terminal to indicate the type of sensing to be executed.

It should be understood that this embodiment of this application sets no limitation on the network device. In some embodiments, the network device may include an AMF and/or an SF.

It should be understood that this embodiment of this application sets no limitation on a type of sensing. In some embodiments, the type of sensing may include: bistatic sensing between terminal devices (UE-UEs sensing), downlink bistatic sensing between a terminal device and an access network device (UE-gNB downlink sensing), uplink bistatic sensing between a terminal device and an access network device (UE-gNB uplink sensing), monostatic sensing of a terminal device (UE monostatic sensing), and the like.

It should be understood that the sensing between terminal devices may be understood as sidelink sensing.

S202: If the type of sensing to be executed is bistatic sensing between devices, the target terminal sends a sensing request to at least one auxiliary terminal.

In this step, after receiving the sensing instruction sent by the network device, the target terminal may recognize the type of sensing to be executed indicated in the sensing instruction. If the type of sensing to be executed is bistatic sensing between devices, the target terminal may send the sensing request to the at least one auxiliary terminal without communicating with the network device.

The sensing request includes configuration information of the sensing signal. Correspondingly, if the type of sensing to be executed is bistatic sensing between devices, the sensing signal may specifically include a sidelink sensing signal.

It should be understood that content of the configuration information of the sensing signal is not limited in this embodiment of this application. In some embodiments, the configuration information of the sensing signal includes at least one of the following: a type of the sensing signal, start and end times of the sensing signal, and a frequency domain resource position of the sensing signal.

The type of the sensing signal may be an existing reference signal, for example, an SSB, a DMRS, CSI, or a PRS; or may be a new reference signal introduced for sensing. This is not limited in this application.

In some optional implementations, the sensing request may be carried in a sidelink discovery message. The sensing request may be sent to one or more auxiliary terminals. Therefore, the sensing request may be sent in a broadcast manner.

It should be noted that a quantity of auxiliary terminals is not limited in this embodiment of this application, and may be one or more. Correspondingly, a plurality of auxiliary terminals may receive the sensing request broadcast by the target terminal, or only one auxiliary terminal may receive the sensing request broadcast by the target terminal.

S203: The auxiliary terminal sends a sensing request response to the target terminal. The sensing request response is used to feed back whether the at least one auxiliary terminal supports sidelink sensing to be executed.

In this step, after the auxiliary terminal receives the sensing request, the auxiliary terminal may send the sensing request response to the target terminal to feed back whether the auxiliary terminal supports the sensing to be executed.

The sensing request response includes configuration information of a sensing signal correspondingly supported by the at least one auxiliary terminal.

In some embodiments, the configuration information that is of the sensing signal and that is in the sensing request response may include information, for example, a suggested type of a sensing signal and a time-frequency position by using which the auxiliary UE can perform SL sensing. An appropriate time-frequency resource may be selected based on the configuration information of the sensing signal when the sensing signal is sent or received.

In some optional implementations, the sensing request response may also be carried in an SL discovery message. Because the sensing request response is sent only to the target terminal, the sensing request response may be sent in a unicast manner. This is different from the sensing request.

S204: The target terminal determines sensing data based on the sensing request response.

In this step, after receiving the sensing request response, the target terminal may determine the sensing data based on the sensing request response.

It should be understood that this embodiment of this application sets no limitation on how to determine the sensing data based on the sensing request response. The target terminal may send the sensing signal and the auxiliary terminal may measure the sensing signal, or the auxiliary terminal may send the sensing signal and the target terminal may measure the sensing signal.

For example, the target terminal may send the sensing signal to the auxiliary terminal on a time-frequency resource indicated by the sensing request response. After receiving the sensing signal, the auxiliary terminal may measure the sensing signal to generate the sensing data. Then, the auxiliary terminal sends the sensing data to the target terminal.

For example, the auxiliary terminal may send the sensing signal to the target terminal on the time-frequency resource indicated by the sensing request response. After receiving the sensing signal, the target terminal may measure the sensing signal to generate the sensing data.

S205: The target terminal sends the sensing data to the network device.

In this application, that the target terminal sends a sensing signal request message to the auxiliary terminal is introduced, and thus sending and receiving of the sensing signal are directly coordinated between the target terminal and the auxiliary terminal, to complete a sensing procedure. On this basis, in the communication method provided in this application, auxiliary information of the sensing signal does not need to be reported to the network device, thereby reducing signaling overheads and a delay. In addition, the auxiliary terminal and the target terminal do not need to be under a same access network device, and even the auxiliary terminal may be outside signal coverage of the access network device.

According to the communication method provided in this embodiment of this application, the target terminal sends the sensing request to the at least one auxiliary terminal. The sensing request includes the configuration information of the sensing signal. In this manner, the target terminal sends the configuration information of the sensing signal to the auxiliary terminal. Sending and receiving of the sensing signal are coordinated between the target terminal and the auxiliary terminal. The configuration information of the sensing signal does not need to be reported to the network device, thereby reducing signaling overheads and a delay.

Based on the foregoing embodiments, the following provides two manners in which the target terminal determines the sensing data.

In a first manner, the target terminal sends the sensing signal, and the auxiliary terminal measures the sensing signal. FIG. 5 is a signaling interaction diagram of another communication method according to an embodiment of this application. As shown in FIG. 5, the method includes the following steps:

S301: A network device sends a sensing instruction to a target terminal. The sensing instruction includes a type of sensing to be executed.

S302: If the type of t sensing to be executed is bistatic sensing between devices, the target terminal sends a sensing request to at least one auxiliary terminal.

S303: The auxiliary terminal sends a sensing request response to the target terminal. The sensing request response is used to feed back whether the at least one auxiliary terminal supports sensing to be executed.

S304: The target terminal sends a sensing signal to the auxiliary terminal on a time-frequency resource indicated by the sensing request response.

S305: The auxiliary terminal measures the sensing signal to generate sensing data.

S306: The auxiliary terminal sends the sensing data to the target terminal.

S307: The target terminal sends the sensing data to a network device.

In a possible design, the type of sensing includes: bistatic sensing between terminal devices, downlink bistatic sensing between a terminal device and an access network device, uplink bistatic sensing between a terminal device and an access network device, and monostatic sensing of a terminal device.

In a possible design, the configuration information of the sensing signal includes at least one of the following: a type of the sensing signal, start and end times of the sensing signal, and a frequency domain resource position of the sensing signal.

In a possible design, the sensing request response includes configuration information of a sensing signal correspondingly supported by the at least one auxiliary terminal.

In a possible design, the sensing request is carried in a sidelink discovery message.

In a possible design, a transmission manner of the sensing request includes broadcast.

In a possible design, the sensing request response is carried in a sidelink discovery message.

In a possible design, a transmission manner of the sensing request response includes unicast.

In a possible design, the network device includes an access and mobility management function network element and/or a sensing control network element.

In a possible design, the sensing signal includes a sidelink sensing signal.

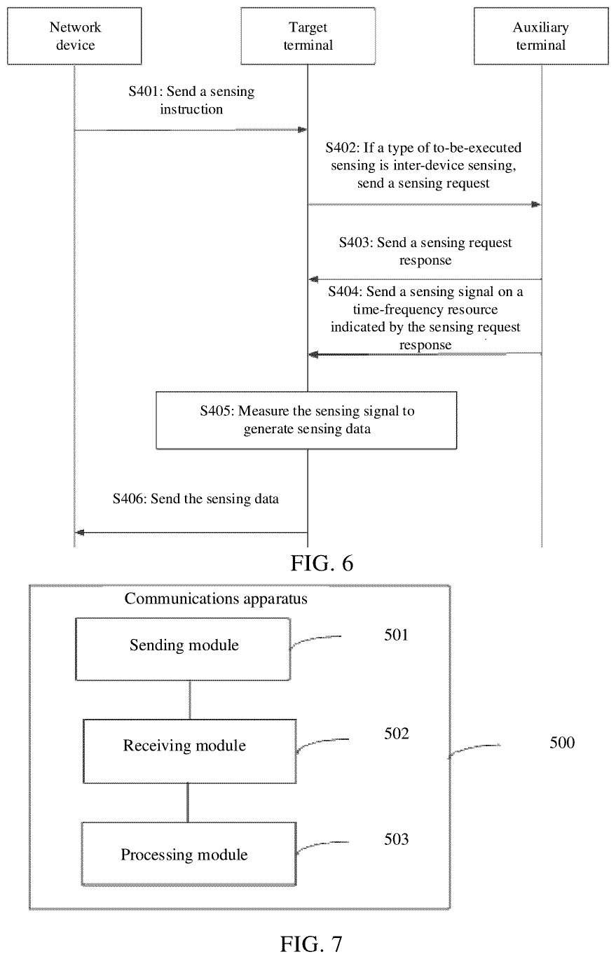

In a second manner, the auxiliary terminal sends the sensing signal, and the target terminal measures the sensing signal. FIG. 6 is a signaling interaction diagram of still another communication method according to an embodiment of this application. As shown in FIG. 6, the method includes the following steps:

S401: A network device sends a sensing instruction to a target terminal. The sensing instruction includes a type of sensing to be executed.

S402: If the type of sensing to be executed is bistatic sensing between devices, the target terminal sends a sensing request to at least one auxiliary terminal.

S403: The auxiliary terminal sends a sensing request response to the target terminal. The sensing request response is used to feed back whether the at least one auxiliary terminal supports sensing to be executed.

S404: The auxiliary terminal sends a sensing signal to the target terminal on a time-frequency resource indicated by the sensing request response.

S405: The target terminal measures the sensing signal to generate sensing data.

S406: The target terminal sends the sensing data to a network device.

In a possible design, the type of sensing includes: bistatic sensing between terminal devices, downlink bistatic sensing between a terminal device and an access network device, uplink bistatic sensing between a terminal device and an access network device, and monostatic sensing of a terminal device.

In a possible design, the configuration information of the sensing signal includes at least one of the following: a type of the sensing signal, start and end times of the sensing signal, and a frequency domain resource position of the sensing signal.

In a possible design, the sensing request response includes configuration information of a sensing signal correspondingly supported by the at least one auxiliary terminal.

In a possible design, the sensing request is carried in a sidelink discovery message.

In a possible design, a transmission manner of the sensing request includes broadcast.

In a possible design, the sensing request response is carried in a sidelink discovery message.

In a possible design, a transmission manner of the sensing request response includes unicast.

In a possible design, the network device includes an access and mobility management function network element and/or a sensing control network element.

In a possible design, the sensing signal includes a sidelink sensing signal.

According to the communication method provided in this embodiment of this application, the target terminal sends the sensing request to the at least one auxiliary terminal. The sensing request includes the configuration information of the sensing signal. In this manner, the target terminal sends the configuration information of the sensing signal to the auxiliary terminal. Sending and receiving of the sensing signal are coordinated between the target terminal and the auxiliary terminal. The configuration information of the sensing signal does not need to be reported to the network device, thereby reducing signaling overheads and a delay.

FIG. 7 is a schematic diagram of a structure of a communications apparatus according to an embodiment of this application. The communications apparatus may be implemented by using software, hardware, or a combination thereof, to perform the communication method on the target terminal side in the foregoing embodiment. As shown in FIG. 7, the communications apparatus 500 includes a sending module 501, a receiving module 502, and a processing module 503.

The sending module 501 is configured to send a sensing request to at least one auxiliary terminal. The sensing request includes configuration information of a sensing signal.

In an optional implementation, the communications apparatus further includes: the receiving module 502, configured to receive a sensing instruction sent by a network device. The sensing instruction includes a type of sensing to be executed.

The sending module 501 is specifically configured to: if the type of sensing to be executed is bistatic sensing between devices, send the sensing request to the at least one auxiliary terminal.

In an optional implementation, the type of sensing includes: bistatic sensing between terminal devices, downlink bistatic sensing between a terminal device and an access network device, uplink bistatic sensing between a terminal device and an access network device, and monostatic sensing of a terminal device.

In an optional implementation, the configuration information of the sensing signal includes at least one of the following: a type of the sensing signal, start and end times of the sensing signal, and a frequency domain resource position of the sensing signal.

In an optional implementation, the receiving module 502 is further configured to receive a sensing request response separately sent by the at least one auxiliary terminal. The sensing request response is used to feed back whether the at least one auxiliary terminal supports sensing to be executed.

In an optional implementation, the sensing request response includes configuration information of a sensing signal correspondingly supported by the at least one auxiliary terminal.

In an optional implementation, the sending module 501 is further configured to send the sensing signal on a time-frequency resource indicated by the sensing request response.

In an optional implementation, the receiving module 502 is further configured to receive sensing data sent by the at least one auxiliary terminal.

The sending module 501 is further configured to send the sensing data to the network device.

In an optional implementation, the receiving module 502 is further configured to receive the sensing signal on a time-frequency resource indicated by the sensing request response.

The communications apparatus further includes: the processing module 503, configured to measure the sensing signal to generate sensing data.

The sending module 501 is further configured to send the sensing data to the network device.

In an optional implementation, the sensing request is carried in a sidelink discovery message.

In an optional implementation, a transmission manner of the sensing request includes broadcast.

In an optional implementation, the sensing request response is carried in a sidelink discovery message.

In an optional implementation, a transmission manner of the sensing request response includes unicast.

In an optional implementation, the network device includes an access and mobility management function network element and/or a sensing control network element.

In an optional implementation, the sensing signal includes a sidelink sensing signal.

The communications apparatus provided in this embodiment of this application may perform actions in the communication method on the target terminal side in the foregoing embodiment. Implementation principles and technical effects thereof are similar. Details are not described herein again.

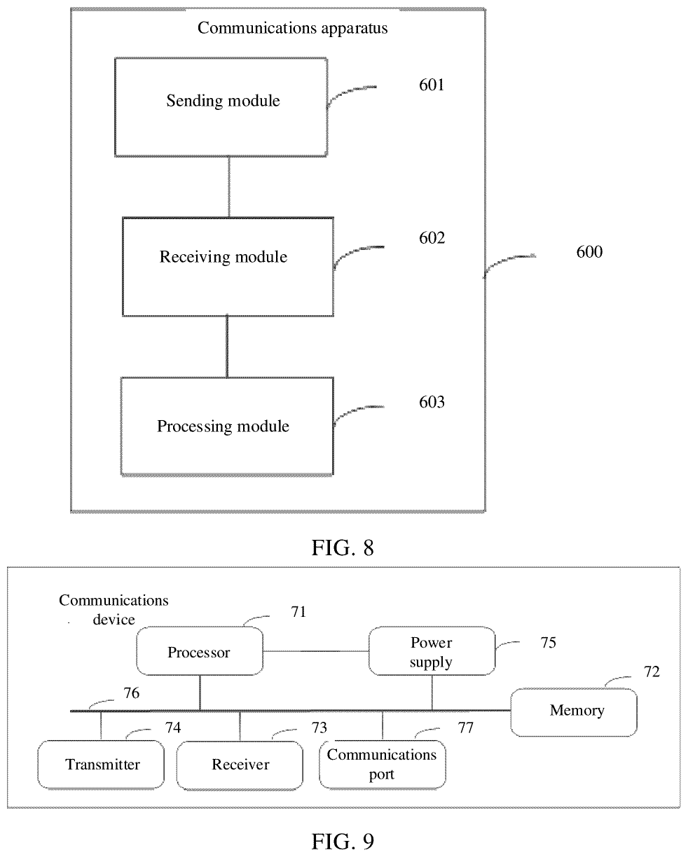

FIG. 8 is a schematic diagram of a structure of another communications apparatus according to an embodiment of this application. The communications apparatus may be implemented by using software, hardware, or a combination thereof, to perform the communication method on the auxiliary terminal side in the foregoing embodiment. As shown in FIG. 8, the communications apparatus 600 includes a sending module 601, a receiving module 602, and a processing module 603.

The receiving module 602 is configured to receive a sensing request sent by a target terminal. The sensing request includes configuration information of a sensing signal.

In an optional implementation, the configuration information of the sensing signal includes at least one of the following: a type of the sensing signal, start and end times of the sensing signal, and a frequency domain resource position of the sensing signal.

In an optional implementation, the communications apparatus further includes:
the sending module 601, configured to send a sensing request response to the target terminal, where the sensing request response is used to feed back whether the communications apparatus supports sensing to be executed.

In an optional implementation, the sensing request response includes configuration information of a sensing signal supported by the communications apparatus.

In an optional implementation, the sending module 601 is specifically configured to send the sensing signal on a time-frequency resource indicated by the sensing request response.

In an optional implementation, the receiving module 602 is further configured to receive the sensing signal on a time-frequency resource indicated by the sensing request response.

The communications apparatus further includes: the processing module 603, configured to measure the sensing signal to generate sensing data.

The sending module 601 is further configured to send the sensing data to the target terminal.

In an optional implementation, the sensing request is carried in a sidelink discovery message.

In an optional implementation, a transmission manner of the sensing request includes broadcast.

In an optional implementation, the sensing request response is carried in a sidelink discovery message.

In an optional implementation, a transmission manner of the sensing request response includes unicast.

In an optional implementation, the sensing signal includes a sidelink sensing signal.

The communications apparatus provided in this embodiment of this application may perform actions in the communication method on the auxiliary terminal side in the foregoing embodiment. Implementation principles and technical effects thereof are similar. Details are not described herein again.

FIG. 9 is a schematic diagram of a structure of a communications device according to an embodiment of this application. As shown in FIG. 9, the communications device may include a processor 71 (for example, a CPU), a memory 72, a receiver 73, and a transmitter 74. The receiver 73 and the transmitter 74 are coupled to the processor 71. The processor 71 controls a receiving action of the receiver 73, and the processor 71 controls a sending action of the transmitter 74. The memory 72 may include a high-speed RAM memory, and may further include a non-volatile memory NVM, for example, at least one disk memory. The memory 72 may store various types of information for completing various processing functions and implement the method steps in embodiments of this application. Optionally, the electronic device in this embodiment of this application may further include a power supply 75, a communications bus 76, and a communications port 77. The receiver 73 and the transmitter 74 may be integrated into a transceiver of the electronic device, or may be an independent transceiver antenna of the electronic device. The communications bus 76 is configured to implement communication and connection between components. The communications port 77 is configured to implement connection and communication between the electronic device and another peripheral device.

In this embodiment of this application, the memory 72 is configured to store computer-executable program code. The program code includes information. When the processor 71 executes the information, the processor 71 is enabled by using the information to perform a processing action on the target terminal side in the foregoing method embodiments, the transmitter 74 is enabled by using the information to perform a sending action on the target terminal side in the foregoing method embodiments, and the receiver 73 is enabled by using the information to perform a receiving action on the target terminal side in the foregoing method embodiments. Implementation principles and technical effects thereof are similar. Details are not described herein again.

Alternatively, when the processor 71 executes the information, the processor 71 is enabled by using the information to perform a processing action on the auxiliary terminal side in the foregoing method embodiments, the transmitter 74 is enabled by using the information to perform a sending action on the auxiliary terminal side in the foregoing method embodiments, and the receiver 73 is enabled by using the information to perform a receiving action on the auxiliary terminal side in the foregoing method embodiments. Implementation principles and technical effects thereof are similar. Details are not described herein again.

An embodiment of this application further provides a communications system, including a target terminal, an auxiliary terminal, and a network device, to perform the foregoing communication method.

An embodiment of this application further provides a chip, including a processor and an interface. The interface is configured to input and output data or instructions processed by the processor. The processor is configured to perform the method provided in the foregoing method embodiments. The chip may be used in the foregoing communications apparatus.

The present application further provides a computer-readable storage medium. The computer-readable storage medium may include any medium that can store program code, for example, a USB flash drive, a removable hard disk, a read-only memory (ROM), a random access memory (RAM), a magnetic disk, or an optical disc. Specifically, the computer-readable storage medium stores program information. The program information is used in the foregoing communication method.

An embodiment of this application further provides a program, and the program is used to perform the communication method provided in the foregoing method embodiments when being executed by a processor.

An embodiment of this application further provides a program product, such as a computer-readable storage medium. The program product stores instructions. When the instructions are run on a computer, the computer is enabled to perform the communication method provided in the foregoing method embodiments.

An embodiment of this application further provides an apparatus. The apparatus may include at least one processor and an interface circuit. Related program instructions are executed in the at least one processor, so that the communications apparatus implements the communication method provided in the foregoing method embodiments.

An embodiment of this application further provides a communications apparatus, and the apparatus is configured to perform the communication method provided in the foregoing method embodiments.

All or some of the foregoing embodiments may be implemented by using software, hardware, firmware, or any combination thereof. When the software is used to implement embodiments, all or some of embodiments may be implemented in a form of a computer program product. The computer program product includes one or more computer instructions. When the computer program instructions are loaded and executed on a computer, the processes or functions described according to embodiments of the present application are all or partly generated. The computer may be a general-purpose computer, a dedicated computer, a computer network, or another programmable apparatus. The computer instructions may be stored in a computer-readable storage medium or transmitted from one computer-readable storage medium to another computer-readable storage medium. For example, the computer instructions may be transmitted from a website, computer, server, or data center to another website, computer, server, or data center in a wired (such as a coaxial cable, an optical fiber, and a digital subscriber line (DSL)) manner or a wireless (such as infrared, wireless, and microwave) manner. The computer-readable storage medium may be any available medium accessible by a computer or a data storage device such as a server or a data center that integrates one or more available media. The available medium may be a magnetic medium (for example, a floppy disk, a hard disk, or a magnetic tape), an optical medium (for example, a DVD), a semiconductor medium (for example, a solid state disk (SSD)), or the like.

Finally, it should be noted that the foregoing embodiments are merely intended for describing the technical solutions of the present application but not for limiting the present application. Although the present application is described in detail with reference to the foregoing embodiments, persons of ordinary skill in the art should understand that they may still make modifications to the technical solutions described in the foregoing embodiments or make equivalent replacements to some or all technical features thereof without departing from the scope of the technical solutions of the embodiments of the present application.

What is claimed is:

1. A communication method, comprising:
sending, by a target terminal, a sensing request to at least one auxiliary terminal, wherein the sensing request comprises configuration information of a sensing signal.

2. The method according to claim 1, wherein before the sending, by a target terminal, a sensing request to at least one auxiliary terminal, the method further comprises:
receiving, by the target terminal, a sensing instruction sent by a network device, wherein the sensing instruction comprises a type of sensing to be executed; and
the sending, by a target terminal, a sensing request to at least one auxiliary terminal comprises:
if the type of sensing to be executed is bistatic sensing between terminal devices, sending, by the target terminal, the sensing request to the at least one auxiliary terminal.

3. The method according to claim 2, wherein the type of sensing comprises: the bistatic sensing between terminal devices, downlink bistatic sensing between a terminal device and an access network device, uplink bistatic sensing between a terminal device and an access network device, and monostatic sensing of a terminal device.

4. The method according to claim 1, wherein the configuration information of the sensing signal comprises at least one of the following: a type of the sensing signal, start and end times of the sensing signal, and a frequency domain resource position of the sensing signal.

5. The method according to claim 1, wherein after the sending, by a target terminal, a sensing request to at least one auxiliary terminal, the method further comprises:
receiving, by the target terminal, a sensing request response separately sent by the at least one auxiliary terminal, wherein the sensing request response is used to feed back whether the at least one auxiliary terminal supports sensing to be executed.

6. The method according to claim 5, wherein the sensing request response comprises configuration information of a sensing signal correspondingly supported by the at least one auxiliary terminal.

7. The method according to claim 5, wherein after the receiving, by the target terminal, a sensing request response sent by the at least one auxiliary terminal, the method further comprises:
sending, by the target terminal, the sensing signal on a time-frequency resource indicated by the sensing request response.

8. The method according to claim 7, wherein after the sending, by the target terminal, the sensing signal on a time-frequency resource indicated by the sensing request response, the method further comprises:
receiving, by the target terminal, sensing data sent by the at least one auxiliary terminal; and
sending, by the target terminal, the sensing data to the network device.

9. The method according to claim 5, wherein after the receiving, by the target terminal, a sensing request response sent by the auxiliary terminal, the method further comprises:
receiving, by the target terminal, the sensing signal on a time-frequency resource indicated by the sensing request response;
measuring, by the target terminal, the sensing signal to generate sensing data; and
sending, by the target terminal, the sensing data to the network device.

10. A terminal device, comprising:
a processor, a memory, a receiver, and an interface for communicating with a network device, wherein
the memory stores computer execution instructions; and
the processor executes the computer execution instructions stored in the memory to enable the terminal device to perform:
sending a sensing request to at least one auxiliary terminal, wherein the sensing request comprises configuration information of a sensing signal.

11. The terminal device according to claim 10, wherein before the sending a sensing request to at least one auxiliary terminal, the processor enables the terminal device to perform:
receiving a sensing instruction sent by a network device, wherein the sensing instruction comprises a type of sensing to be executed; and
the sending a sensing request to at least one auxiliary terminal comprises:
if the type of sensing to be executed is bistatic sensing between terminal devices, sending the sensing request to the at least one auxiliary terminal.

12. The terminal device according to claim 10, wherein after the sending a sensing request to at least one auxiliary terminal, the processor enables the terminal device to perform:
receiving a sensing request response separately sent by the at least one auxiliary terminal, wherein the sensing request response is used to feed back whether the at least one auxiliary terminal supports sensing to be executed.

13. The terminal device according to claim 12, wherein the sensing request response comprises configuration information of a sensing signal correspondingly supported by the at least one auxiliary terminal.

14. The terminal device according to claim 13, wherein after sending the sensing signal on a time-frequency resource indicated by the sensing request response, the processor enables the terminal device to perform:
receiving sensing data sent by the at least one auxiliary terminal; and
sending the sensing data to the network device.

15. The terminal device according to claim 12, wherein after the receiving a sensing request response sent by the auxiliary terminal, the processor enables the terminal device to perform:
receiving the sensing signal on a time-frequency resource indicated by the sensing request response;
measuring the sensing signal to generate sensing data; and
sending the sensing data to the network device.

16. A terminal device, comprising:
a processor, a memory, a receiver, and an interface for communicating with a network device, wherein
the memory stores computer execution instructions; and
the processor executes the computer execution instructions stored in the memory to enable the terminal device to perform:
receiving a sensing request sent by a target terminal, wherein the sensing request comprises configuration information of a sensing signal.

17. The terminal device according to claim 16, wherein after the receiving a sensing request sent by a target terminal, the processor enables the terminal device to perform:
sending a sensing request response to the target terminal, wherein the sensing request response is used to feed back whether the auxiliary terminal supports sensing to be executed.

18. The terminal device according to claim 17, wherein the sensing request response comprises configuration information of a sensing signal supported by the auxiliary terminal.

19. The terminal device according to claim 17, wherein after the sending a sensing request response to the target terminal, the processor enables the terminal device to perform:
sending the sensing signal on a time-frequency resource indicated by the sensing request response.

20. The terminal device according to claim 17, wherein after the sending a sensing request response to the target terminal, the processor enables the terminal device to perform:
receiving the sensing signal on a time-frequency resource indicated by the sensing request response;
measuring the sensing signal to generate sensing data; and
sending the sensing data to the target terminal.
